(19) United States
(12) Patent Application Publication
(10) Pub. No.: US 2026/0092779 A1
(43) Pub. Date: Apr. 2, 2026

(54) METHOD AND DEVICE FOR DETECTING A SIGNAL CHARACTERISTIC OF A SENSOR SIGNAL ORIGINATING FROM A SENSOR

(71) Applicant: Robert Bosch GmbH, Stuttgart (DE)

(72) Inventors: Lukas Grinewitschus, Reutlingen (DE); Nicolai Markiewicz, Salzgitter Bad (DE); Surya Abhishek Singaraju, Reutlingen (DE); Andreas Pruemm, Stuttgart (DE); Andreas Maximilian Damm, Kassel (DE); John Britto Arul Christopher, Koramangala Bangalore (IN); Lucian Vasile Stoica, Nandlstadt (DE); Marco Van De Logt, Reutlingen (DE); Michael Hesz, Tuebingen (DE); Tongtong Jiao, Shanghai (CN); Ulrich Ellerkmann, Boeblingen (DE); Valeria Toffoli, Reutlingen (DE); Yunfei Zhao, Shanghai (CN)

(21) Appl. No.: 19/299,574

(22) Filed: Aug. 14, 2025

(30) Foreign Application Priority Data
Sep. 30, 2024 (DE) 10 2024 209 518.4

(51) Int. Cl. G01C 19/5776; G01C 19/5712

(52) U.S. Cl. CPC G01C 19/5776; G01C 19/5712

(57) ABSTRACT

A method and device for detecting a signal characteristic of a sensor signal originating from a sensor. The method includes: sampling the sensor signal at a sampling rate to generate sample values; calculating a correlation measure for the sensor signal by summing up the absolute differences between two consecutive sample values of a sampling sequence of the sampled sensor signal, wherein the sampling sequence includes a certain number, N, of sample values; and determining a signal characteristic of the sensor signal on the basis of the calculated correlation measure.

### CROSS REFERENCE

The present application claims the benefit under 35 U.S.C. § 119 of Germany Patent Application No. DE 10 2024 209 518.4 filed on Sep. 30, 2024, which is expressly incorporated herein by reference in its entirety.

### FIELD

The present invention provides a method and a device for detecting a signal characteristic of a sensor signal originating from a sensor, in particular a signal originating from a MEMS sensor, and in particular a method and a device for extending the operating life of a sensor by switching to a special operating mode after a malfunction of the sensor has been detected.

### BACKGROUND INFORMATION

Europe Patent Application No. EP 2399099 A1 describes a MEMS gyroscope with tunable drive frequency.

In microelectromechanical systems (MEMS), leakage currents usually arise from a short circuit at the electrodes when a particle is chipped off of the moving body and attaches to the electrode below. Such a short circuit at the electrodes can result in strong noise in the output characteristics of the sensor. The impact energy on the sensor plays an important role in the detachment of particles. Flaking off of particles due to high impact energy leads to polysilicon particles of different sizes and the distribution thereof, for example in MEMS inertial sensors. Chips from the suspended mass, which can be several μm in size, remain stuck to the stopper. However, due to the high impact energies, the chips can also reach a distance of several μm away from the impact point. Kinetic impact energies of up to 40 nJ (1-3 m/s for most inertial sensor masses) can correlate with silicon fracture and further particle flaking, resulting in leakage current and high noise. To avoid flaking particles, conventional considerations can be made to change the design of the various shock absorber shapes in the fixed/moving parts. Various shock absorber geometries can be used for this, such as sharp, flat or round. Sharp uneven areas result in less flaking than round and flat ones, because the test mass is deflected by the sharp geometry after impact and the energy balance between mass, suspension springs and unevenness occurs in a different way. The kinetic energy is transferred to the lateral deflection of the springs rather than to the deformation of the shock/mass (and possible failure). While the design of shock absorbers can in principle improve the robustness of inertial sensors to large shocks, real devices often have distributed shock absorber arrangements, rather than a single shock absorber.

Another conventional approach to avoid the noise without requiring a design change of the MEMS sensor is to use positive electromechanical feedback (EMF) at the pull-in point, which is substantially defined as the voltage at which a pull-in effect occurs between two capacitor plates of the MEMS structure due to electrostatic attraction. However, the intrinsic measurement resolution of capacitive MEMS sensors is difficult to achieve with standard integrated electronics. This is usually due to a mismatch between the MEMS component and the readout electronics. This mismatch occurs because standard readout devices generally prefer small or medium source impedances, whereas MEMS devices have high impedance. It is also understood that CMOS circuits have a large 1/f noise contribution. One way to reduce impedance mismatch and 1/f noise is to use RF readout techniques that utilize a small-signal model in noise and stability analysis.

The capacitance of a MEMS sensor, described by the moving mass m and the spring constant k, can be monitored using an RF capacitance bridge. The output signal of the capacitance bridge is down-converted, amplified and fed back to the MEMS device. Since the carrier frequency is far above the mechanical frequency band of the MEMS, the equivalent force noise of any readout amplifier at the pull-in pin can be completely eliminated. The contribution of readout noise increases with frequency at the pull-in point, resulting in a limitation of the noise-adjusted bandwidth. The flaking of particles can therefore lead to leakage currents, which can be reduced by changes to the hardware, e.g. the bumper shape, or by 1/f noise suppression. However, the conventional approach, which requires a change in the hardware, requires the provision of complex noise suppression circuits.

Conventional noise detection methods typically use reference signals to correlate with the signal in question. However, such a reference signal is not available in many cases and can therefore only be generated by the provision of a corresponding reference signal generator, which increases the complexity of the circuit. With regard to noise detection, conventional approaches are usually associated with a higher computational effort. Either the calculation involves more processing steps or the signal of interest must be compared with a reference signal.

### SUMMARY

According to a first aspect, the present invention provides a method for detecting a signal characteristic of a sensor signal originating from a sensor. According to an example embodiment of the present invention, the method comprises the following steps: sampling the sensor signal at a sampling rate to generate sample values; calculating a correlation measure for the sensor signal by summing up the absolute differences between two consecutive sample values of a sampling sequence of the sampled sensor signal, wherein the sampling sequence comprises a certain number of sample values; and determining a signal characteristic of the sensor signal on the basis of the calculated correlation measure.

A significant advantage of the method according to the present invention is that only the sensor signal originating from the sensor is processed and no separate reference signal is required.

This represents a substantial simplification of the circuitry and reduces the complexity of the signal processing. In addition, the possible applications are expanding.

The method according to the present invention does not require any changes to an existing circuit and is preferably based on appropriately adapted software.

The method according to the present invention offers an efficient option for detecting noise in a sensor signal.

The method according to the present invention is therefore suitable for all sensors that provide an analog sensor signal, in particular for MEMS sensors.

The monitoring of the sensor signal using the method according to the present invention can be carried out continuously in the background. The data processing of the monitored sensor signal preferably takes place in real time.

In one possible example embodiment of the method according to the present invention for detecting a signal characteristic of a sensor signal originating from a sensor, the calculated correlation measure is compared with a threshold value.

In one possible example embodiment of the method according to the present invention for detecting a signal characteristic of a sensor signal originating from a sensor, the sensor signal is classified as noise-like if the calculated correlation measure is above the threshold value.

The threshold value can be predefined. Alternatively, the threshold value can be set via an interface.

In one possible example embodiment of the method according to the present invention for detecting a signal characteristic of a sensor signal originating from a sensor, the sensor signal is classified as regular if the calculated correlation measure is below the threshold value.

In one possible example embodiment of the method according to the present invention for detecting a signal characteristic of a sensor signal originating from a sensor, the sensor signal is classified as constant if the calculated correlation measure is zero.

In one possible example embodiment of the method according to the present invention for detecting a signal characteristic of a sensor signal originating from a sensor, the sample values of the sampling sequence are temporarily stored and the correlation measure is calculated on the basis of the temporarily stored sample values of the sampling sequence.

In one possible example embodiment of the method according to the present invention for detecting a signal characteristic of a sensor signal originating from a sensor, the correlation measure is calculated iteratively without temporary storage of the sample values of the sampling sequence. This allows a lower latency to be achieved.

In one possible example embodiment of the method according to the present invention for detecting a signal characteristic of a sensor signal originating from a sensor, a further correlation measure for the sensor signal is calculated by summing up the products of two consecutive sample values of a sampling sequence of the sampled sensor signal, wherein the sampling sequence comprises a certain number of sample values.

The number N of sample values in the sampling sequence can be fixed. Alternatively, the number N of sample values in the sampling sequence can be adjusted for the particular application. A dynamic adjustment of the number N of sample values during operation of the sensor is also possible. The number N of sample values of the temporarily stored sampling sequence can for example be set depending on a tolerable latency time.

In one possible example embodiment of the method according to the present invention for detecting a signal characteristic of a sensor signal originating from a sensor, the two correlation measures (d1, c1) calculated for the sensor signal are stored in pairs. This makes it possible for a signal characteristic of the sensor signal to be determined more specifically.

In one possible example embodiment of the method according to the present invention for detecting a signal characteristic of a sensor signal originating from a sensor, a ratio between the two correlation measures (d1, c1) is calculated. This makes it possible for the signal characteristics of the sensor signal to be determined even more specifically.

In one possible example embodiment of the method according to the present invention for detecting a signal characteristic of a sensor signal originating from a sensor, the signal characteristic of the sensor signal is further specified depending on the calculated ratio of the two correlation measures (d1, c1).

In one possible example embodiment of the method according to the present invention for detecting a signal characteristic of a sensor signal originating from a sensor, it is assessed on the basis of the determined signal characteristic of the sensor signal whether the sensor is operating correctly or has a malfunction.

In one possible example embodiment of the method according to the present invention for detecting a signal characteristic of a sensor signal originating from a sensor, an operating mode for handling the detected malfunction is automatically activated after a malfunction in the sensor has been detected.

The treatment of a detected sensor malfunction can vary depending on the application. The sensor can be deactivated and/or its sensor signal can be ignored. It is also possible to switch over from another, redundant sensor of the same type. In addition, an error or warning message can be output to a higher-level controller of an assistance system and/or an operating mode provided specifically for this purpose can be activated.

In one possible example embodiment of the method according to the present invention for detecting a signal characteristic of a sensor signal originating from a sensor, the sensor signal is output by a MEMS sensor of a gyroscope.

According to a further aspect, the present invention provides a program for detecting a signal characteristic of a sensor signal originating from a sensor, with program instructions for carrying out the method according to the present invention. Alternatively, the method steps of the method according to the present invention can also be implemented in hardwired fashion.

The present invention further provides a device for detecting a signal characteristic of a sensor signal originating from a sensor. According to an example embodiment of the present invention, the device comprises a sampling unit that samples the sensor signal at a sampling rate to generate sample values; a calculation unit that calculates a correlation measure for the sensor signal by summing up the absolute differences between two consecutive sample values of a sampling sequence of the sampled sensor signal, wherein the sampling sequence comprises a certain number of sample values; and a determination unit that determines a signal characteristic of the sensor signal on the basis of the calculated correlation measure.

In one possible example embodiment of the device according to the present invention for detecting a signal characteristic of a sensor signal originating from a sensor, the determination unit has a comparator which compares the correlation measure calculated by the calculation unit with an adjustable or fixed threshold value, wherein the sensor signal is classified by the determination unit as noise-like if the calculated correlation measure is above the threshold value, wherein the sensor signal is classified by the determination unit as regular if the calculated correlation measure is below the threshold value, and wherein the sensor signal is classified by the determination unit as constant if the calculated correlation measure is zero.

In one possible example embodiment of the device according to the present invention for detecting a signal characteristic of a sensor signal originating from a sensor, the device has a buffer memory for temporarily storing the sample values of the sampling sequence generated by the sampling unit.

In one possible example embodiment of the device according to the present invention for detecting a signal characteristic of a sensor signal originating from a sensor, the calculation unit of the device calculates a further correlation measure for the sensor signal by summing up the products of two consecutive sample values of a sampling sequence of the sampled sensor signal, wherein the sampling sequence comprises a certain number of sample values.

In one possible example embodiment of the device according to the present invention for detecting a signal characteristic of a sensor signal originating from a sensor, the two correlation measures (d1, c1) calculated by the calculation unit for the sensor signal are stored in pairs in a data memory of the device.

In one possible example embodiment of the device according to the present invention for detecting a signal characteristic of a sensor signal originating from a sensor, the calculation unit of the device calculates a ratio between the two correlation measures.

In one possible example embodiment of the device according to the present invention for detecting a signal characteristic of a sensor signal originating from a sensor, the determination unit of the device further specifies the signal characteristic of the sensor signal on the basis of the ratio, calculated by the calculation unit, between the two correlation measures (d1, c1).

In one possible example embodiment of the device according to the present invention for detecting a signal characteristic of a sensor signal originating from a sensor, an assessment unit of the device assesses, on the basis of the determined signal characteristic of the sensor signal, whether the sensor is functioning correctly or has a malfunction.

In one possible example embodiment of the device according to the present invention for detecting a signal characteristic of a sensor signal originating from a sensor, the assessment unit outputs an activation signal for activating an operating mode for handling a malfunction of the sensor if a malfunction of the sensor is detected on the basis of the determined signal characteristic.

The present invention further provides a system with at least one sensor and a device for detecting a signal characteristic of a sensor signal originating from the sensor. According to an example embodiment of the present invention, the system comprises: a sampling unit that samples the sensor signal at a sampling rate to generate sample values; a calculation unit that calculates a correlation measure for the sensor signal by summing up the absolute differences between two consecutive sample values of a sampling sequence of the sampled sensor signal, wherein the sampling sequence comprises a certain number of sample values; and a determination unit that determines a signal characteristic of the sensor signal based on the calculated correlation measure.

In one possible example embodiment of the system of the present invention, the sensor is a MEMS sensor.

In the following, possible embodiments of the method according to the present invention and of the device according to the present invention are described in more detail below with reference to the figures.

### BRIEF DESCRIPTION OF THE DRAWINGS

FIG. 1 is a flow diagram representing a possible embodiment of the method according to the present invention.

FIG. 2 is a block diagram representing a possible embodiment of the device according to the present invention.

FIG. 3 is a further flow diagram representing a possible embodiment of the method according to the present invention.

FIG. 4A, 4B are signal diagrams explaining the functioning of the method and the device according to the present invention.

FIG. 5 is a diagram representing a correlation measure calculated for signal characterization.

FIG. 6 is a diagram representing another correlation measure calculated for signal characterization.

FIG. 7 is a diagram representing a correlation measure calculated for signal characterization.

### DETAILED DESCRIPTION OF EXAMPLE EMBODIMENTS

The figures are intended to impart further understanding of the embodiments of the present invention. They illustrate embodiments and, in connection with the description, serve to explain certain principles and concepts of the present invention. Other embodiments and many of the mentioned advantages are apparent from the figures. The elements of the figures are not necessarily shown to scale relative to one another.

In the figures, identical, functionally identical and identically acting elements, features and components are provided with the same reference signs in each case, unless otherwise stated.

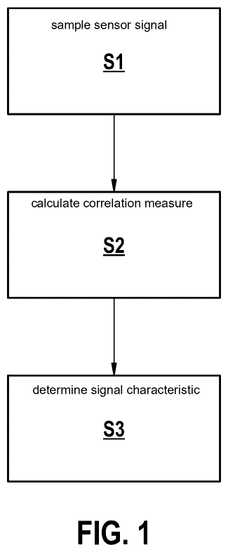

As shown in FIG. 1, the method according to the present invention for detecting a signal characteristic of a sensor signal SIG originating from a sensor 2 comprises a plurality of main steps.

In a first step S1, the sensor signal SIG is sampled at a sampling rate R to generate sample values (x). The sampling rate R can be fixed or set by an internal controller.

In a further step S2, a correlation measure (d1) for the sensor signal SIG is calculated by summing up the absolute differences between two consecutive sample values (xi+1; xi) of a sampling sequence of the sensor signal SIG sampled in step S1, wherein the sampling sequence comprises a certain number, N, of sample values.

In a further step S3, a signal characteristic (SC) of the sensor signal SIG is determined on the basis of the correlation measure (d1) calculated in step S2.

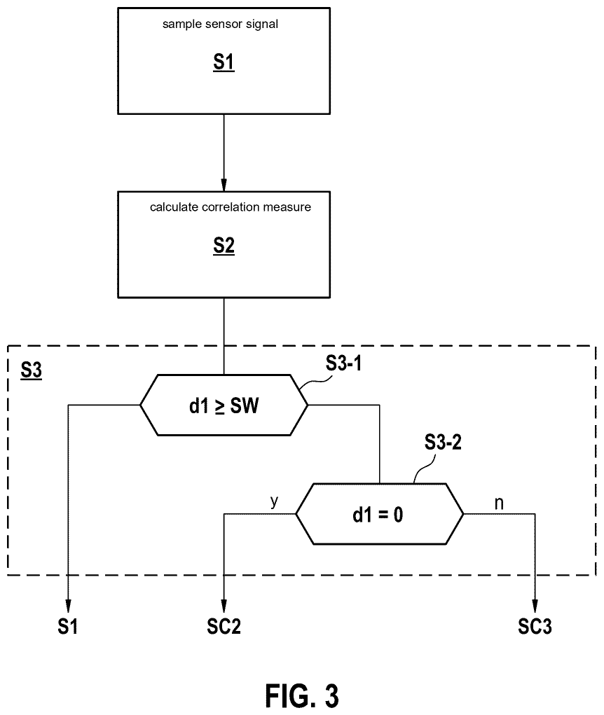

In one possible embodiment of the method according to the present invention for detecting a signal characteristic SC of a sensor signal SIG originating from a sensor 2, the sensor signal is classified as noise-like (SC1) in step S3 if the calculated correlation measure (d1) is above an adjustable or predefined threshold value (SW), as shown in the flow diagram according to FIG. 3.

In one possible embodiment of the method according to the present invention for detecting a signal characteristic SC of a sensor signal originating from a sensor 2, the sensor signal SIG is classified as regular (SC2) if the calculated correlation measure (d1) is below the threshold value (SW).

In one possible embodiment of the method according to the present invention for detecting a signal characteristic SIG of a sensor signal originating from a sensor 2, the sensor signal SIG is classified as constant (SC3) if the calculated correlation measure (d1) is zero.

In one possible embodiment of the method according to the present invention for detecting a signal characteristic of a sensor signal originating from a sensor 2, the sample values of the sampling sequence are temporarily stored and the calculation of the correlation measure (d1) in step S2 is carried out on the basis of the sample values of the sampling sequence temporarily stored in a buffer memory.

In one possible alternative embodiment of the method according to the present invention for detecting a signal characteristic of a sensor signal SIG originating from a sensor 2, the correlation measure d1 is calculated iteratively in step S2 without temporary storage of the sample values of the sampling sequence.

It is also possible to switch between iterative and non-iterative calculation. For example, for time-critical applications that require low latency, an iterative calculation of the correlation measure d1 can be activated.

In one possible embodiment of the method according to the present invention for detecting a signal characteristic SC of a sensor signal SIG originating from a sensor 2, in step S3 a further correlation measure (c1) for the sensor signal SIG is calculated by summing up the products of two consecutive sampling values (xi+1; xi) of a sampling sequence of the sampled sensor signal, wherein the sampling sequence comprises a certain number, N, of sampling values.

In a further possible embodiment of the method according to the present invention for detecting a signal characteristic SC of a sensor signal SIG originating from a sensor 2, the two correlation measures (d1, c1) calculated for the sensor signal SIG in step S3 are stored in pairs.

In one possible embodiment of the method according to the present invention for detecting a signal characteristic SC of a sensor signal SIG originating from a sensor 2, a ratio v between the two correlation measures (d1, c1) is also calculated in step S3.

In one possible embodiment of the method according to the present invention for detecting a signal characteristic of a sensor signal SIG originating from a sensor 2, the signal characteristic SC of the sensor signal SIG is further specified depending on the ratio v, calculated in step S3, of the two correlation measures (d1, c1). Preferably, the signal characteristic is further specified depending on the ratio of the two correlation measures to each other for a certain value of one of the two correlation measures.

In one possible embodiment of the method according to the present invention for detecting a signal characteristic of a sensor signal originating from a sensor 2, the determined signal characteristic SC of the sensor signal SIG is used to assess whether the sensor 2 is operating correctly or has a malfunction. After a malfunction of the sensor 2 has been detected, an operating mode for dealing with the detected malfunction can be automatically activated.

In one possible embodiment of the method according to the present invention for detecting a signal characteristic SC of a sensor signal originating from a sensor 2, the sensor signal SIG is output by a MEMS sensor 2 of a gyroscope. However, the method is suitable for a variety of other sensors that provide an analog sensor signal.

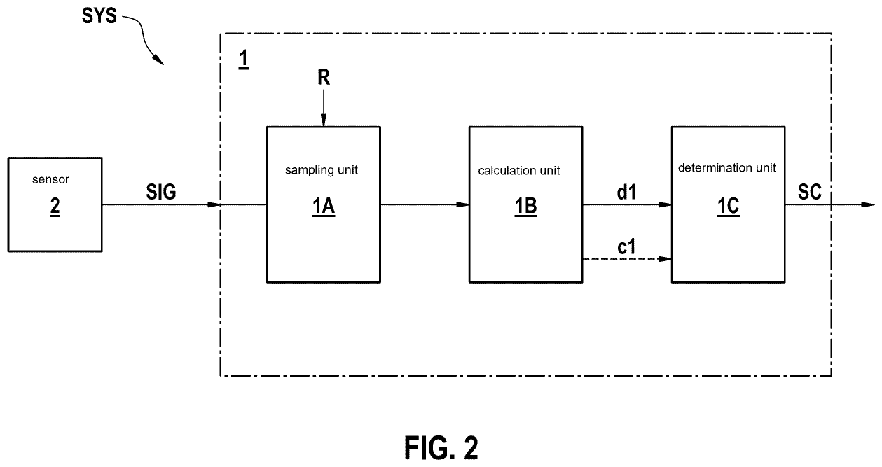

FIG. 2 shows an exemplary embodiment of a device 1 according to the present invention for detecting a signal characteristic (SC) of a sensor signal SIG originating from a sensor 2, with a sampling unit 1A which samples the sensor signal SIG at a sampling rate R to generate sample values (x). The sampling rate R can be predefined for the sensor 2 to be monitored. The sampling rate can also be set by a local controller of the device 1 depending on a configuration, for example depending on the sensor type and/or the application. In one possible embodiment, the sampling unit 1A can be integrated into the sensor 2.

The device 1 also has a calculation unit 1B which calculates a correlation measure (d1) for the sensor signal SIG by summing up the absolute differences between two consecutive sample values (xi+1; xi) of a sampling sequence of the sampled sensor signal SIG, wherein the sampling sequence comprises a certain number, N, of sample values. The calculation unit 1B may comprise a processor, an FPGA or an ASIC.

The device 1 further comprises a determination unit 1C, which determines a signal characteristic SC of the sensor signal SIG on the basis of the correlation measure d1 calculated by the calculation unit 1B. In one possible embodiment of the device 1 according to the present invention for detecting a signal characteristic SC of a sensor signal SIG originating from a sensor 2, the determination unit 1C has a comparator which compares the correlation measure (d1) calculated by the calculation unit 1B with a threshold value SW. The sensor signal SIG is classified as noise-like by the determination unit 1C if the calculated correlation measure (d1) is above the threshold value SW. The sensor signal SIG is classified as regular by the determination unit 1C if the calculated correlation measure (d1) is below the threshold value SW. The sensor signal SIG is classified as constant by the determination unit 1C if the calculated correlation measure (d1) calculated by the calculation unit 1B is zero.

In one possible embodiment of the device according to the present invention for detecting a signal characteristic of a sensor signal SIG originating from a sensor 2, the device 1 further comprises a buffer memory for temporarily storing the sample values of the sampling sequence generated by the sampling unit 1A. The sampling sequence comprises a certain number, N, of sample values. This number N can be fixedly defined. Alternatively, the number N of sample values can also be dynamically adjusted during operation of the sensor 2, for example in response to detected events or depending on a required maximum latency of the device 1.

In one possible embodiment of the device according to the present invention for detecting a signal characteristic SC of a sensor signal SIG originating from a sensor 2, the calculation unit 1B of the device 1 calculates a further correlation measure (c1) for the sensor signal SIG by summing up the products of two consecutive sample values (xi+1; xi) of a sampling sequence of the sampled sensor signal, wherein the sampling sequence comprises a certain number, N, of sample values.

In one possible embodiment of the device according to the present invention for detecting a signal characteristic SC of a sensor signal SIG originating from a sensor 2, the two correlation measures (d1, c1) calculated by the calculation unit 1B for the sensor signal SIG are stored in pairs in a data memory of the device 1.

The calculation unit 1B of the device 1 can calculate a ratio v between the two correlation measures (d1, c1) by dividing the two correlation values (v=d1/c1). In one possible embodiment of the device 1, a signal characteristic SC of the sensor signal SIG can be further specified on the basis of the ratio v, calculated by the calculation unit 1B, between the two correlation measures (d1, c1) for a value of one of the two correlation measures.

In one possible embodiment of the device according to the present invention for detecting a signal characteristic of a sensor signal SIG originating from a sensor 2, an assessment unit assesses, on the basis of the determined signal characteristic SC of the sensor signal SIG, whether the sensor 2 is functioning correctly or has a malfunction. The assessment unit can output an activation signal for activating an operating mode for handling a malfunction of the sensor 2 if a malfunction of the sensor 2 is detected on the basis of the determined signal characteristic SC.

The present invention further provides a system SYS with at least one sensor 2 and a device 1 for detecting a signal characteristic SC of a sensor signal SIG originating from the sensor 2, comprising a sampling unit 1A which samples the sensor signal SIG at a sampling rate R to generate sample values (x), a calculation unit 1B which calculates a correlation measure (d1) for the sensor signal SIG by summing up the absolute differences between two consecutive sample values (xi+1; xi) of a sampling sequence of the sampled sensor signal SIG, wherein the sampling sequence comprises a certain number, N, of sample values, and a determination unit 1C which determines a signal characteristic SC of the sensor signal SIG on the basis of the calculated correlation measure d1. In one possible embodiment of the system SYS shown in FIG. 2, the sensor 2 is a MEMS sensor. In one possible implementation, the device 1 can also be integrated into a housing of a sensor 2 to be monitored.

In one possible embodiment, a decision is also made as to whether an enhanced coverage mode (EC) should be switched on in order to obtain a “high robustness” of the signal sensor 2. To decide whether the EC mode should be triggered or not, the signal SIG of sensor 2, for example a gyroscope, is analyzed. The gyroscope signal has certain features that Indicate that the EC mode should be turned on. These signal features are detected by an algorithm according to the method of the present invention in order to automate the triggering of the EC mode.

Substantially, two different signal features or signal characteristics SC can be distinguished from a normal gyroscope signal. The main feature of the first signal characteristic SC1 is strong noise. The noise is broadband and is assumed to be white.

The main feature of the second signal characteristic SC2 is that the signal from one of the three gyroscope axes is fixed, or constant.

A gyroscope typically provides three sensor signals SIG that measure the angular velocity about the three orthogonal axes. These axes are usually referred to as the x-, y-, and z-axes. Each of these signals SIG represents the rate of rotation about one of the three axes. The three main signals provided by a gyroscope include:

Angular velocity about the x-axis: This measures the rotational movement about the x-axis (roll).

Angular velocity about the y-axis: This measures the rotational movement about the y-axis (pitch).

Angular velocity about the z-axis: This measures the rotational movement about the z-axis (yaw).

These three sensor signals SIG of the gyroscope together make it possible to fully characterize the rotational movements of an object to which the gyroscope is attached. Modern gyroscopes, such as those used in smartphones, drones, and vehicles, continuously provide these three sensor signals, which can then be used to control, navigate, or stabilize the system. Signals SIG which have unusual signal characteristics, in particular the first signal characteristic SC1 (noise) and the second signal characteristic SC2 (fixed or constant signal), must be distinguished from a normal gyroscope signal.

In one possible embodiment, an associated device 1 for detecting a signal characteristic SC of the sensor signal SIG is provided for each of the three sensor signals SIG of the gyroscope. Alternatively, the sensor signals SIG, after sampling, can be switched one after the other to the signal input of the calculation unit 1B by a multiplexer. As soon as a malfunction in one of the three sensor signals is detected, the malfunction is automatically handled appropriately.

Since the noise is high in the case of the first signal characteristic (SC1), the variance VAR of the gyroscope signal represents a possible criterion that can be used for the differentiation. However, a disadvantage of using the variance VAR is that the variance VAR of a signal does not contain any information about the correlation of the subsequent sampling of this signal. However, this is of interest here because the distinguishing should also work when the sensor 2 is moving.

In this case, it is possible to use a third signal feature (SC3) that also has a high variance VAR, e.g. a signal SS that has the shape of a sinusoid curve. In these cases, however, the algorithm should not choose the first signal feature SC1, but the third signal feature SC3.

The method according to the present invention uses a measure d1 which comprises the correlation between consecutive samples within a time frame of N samples. In the case of a sinusoidal signal SS, the subsequent sample values are strongly correlated. A noise signal RS, for example white noise, on the other hand, leads to a low correlation value d1 between consecutive sample values, since ideally each sample of the noise signal RS is statistically independent and therefore uncorrelated.

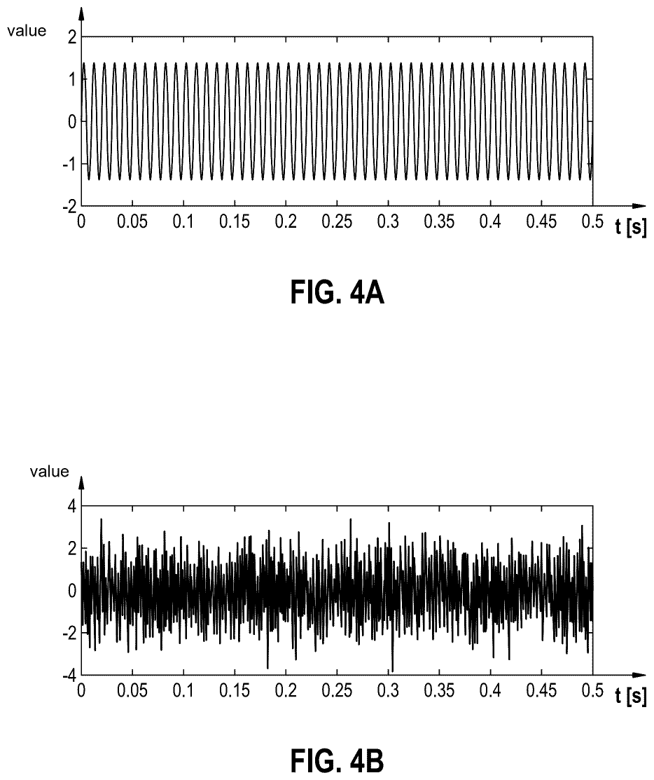

In FIG. 4A, 4B, two signals SS, RS are shown. The upper graph (FIG. 4A) shows a sinusoidal signal SS with a frequency of 100 Hz. In the lower diagram (FIG. 4B), a random white noise signal RS is plotted. The x-axis represents the time t in seconds (s) and the y-axis represents the value of the signal in arbitrary units. The sampling rate R of the two signals shown in FIG. 4A, 4B is 6.4 kHz.

The signals in FIG. 4A, 4B both have a variance VAR of approximately one. Therefore, it is not possible to distinguish between these two signals SS, RS based on the variance VAR. If the correlation between consecutive samplings for both signals SS, RS in FIG. 4A, 4B is calculated, the correlation values are 6.4·104 and −204, respectively. The absolute value therefore differs by a factor of more than 312, so that a clear distinction is possible between the sinusoidal signal SS shown in FIG. 4A and the noise signal RS shown in FIG. 4B.

In the following equation (1), a correlation value c1 between consecutive samples, or sample values, for a frame of length N is indicated:

$${c}_{1} = {\sum }_{i = 1}^{N - 1} {x}_{i + 1} \cdot {x}_{i} ,$$

where xi is the value of the i-th sample value of the signal SIG.

However, the use of the correlation function used in equation (1) has disadvantages with regard to the signal features to be classified, in particular to detect the second signal feature SC2. The main feature of the second signal characteristic SC2 is that the signal from one of the three gyroscope axes is fixed, or constant. The correlation between consecutive sample values must be maximum, since the consecutive sample values do not differ from each other in the case of the second signal feature SC2. This raises a problem, namely the definition of the maximum value.

When calculating equation (1), it is not known whether the calculated value is the maximum value of the autocorrelation function. For this purpose, the following equation (2) must also be calculated to obtain an indication. However, this requires additional calculation.

$${c}_{0} = {\sum }_{i = 1}^{N} {x}_{i} \cdot {x}_{i}$$

On the other hand, there are also difficulties in detecting the first signal feature SC1 when the signal SIG is very noisy. For noise RS, the correlation value is lower than for example for a sine curve SS. However, this also depends on the amplitude of the sine curve SS. This can make it difficult to distinguish between the two classes or signal characteristics SC1 (noise signal RS) and SC3 (sinusoidal signal SS).

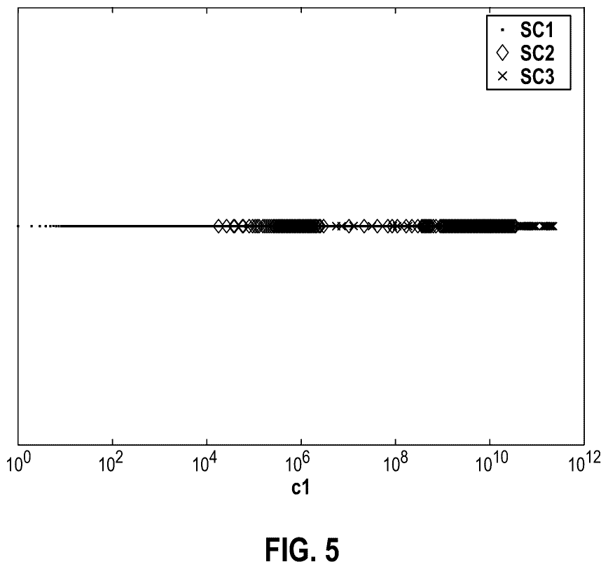

Overall, a distinction between the three signal characteristics SC1, SC2, SC3 is not possible solely with the correlation value c1 calculated according to equation (1), as can be seen in FIG. 5. In FIG. 5, the first correlation value defined in equation (1) is c1 for different frames of signals with different signal characteristics SC. The correlation value c1 is plotted on the x-axis, and the correlation value c1 is marked with different markers depending on the underlying signal characteristic SC.

As can be seen in FIG. 5, the correlation values c1 for the three different signal characteristics SC1, SC2, SC3 overlap strongly. Therefore, it is not possible to successfully distinguish between the three signal characteristics SC1, SC2, SC3 with this calculated correlation measure or correlation value c1 alone.

Instead of the correlation value c1 defined in equation (1), the method according to the present invention primarily uses a different measure for the correlation between consecutive samples or sampling values.

This correlation measure d1 is defined in equation (3) as follows:

$${d}_{1} = {\sum }_{i = 1}^{N - 1} \vert {x}_{i + 1} \cdot {x}_{i} \vert$$

The second correlation measure d1 in equation (3) is the so-called taxicab difference between two vectors x1 and x2, with:

$${\vec{x}}_{1} = [ \begin{matrix}{x}_{2} \\ {x}_{3} \\ ⋮ \\ {x}_{N}\end{matrix} ] , {\vec{x}}_{2} = [ \begin{matrix}{x}_{1} \\ {x}_{2} \\ ⋮ \\ {x}_{N - 1}\end{matrix} ] .$$

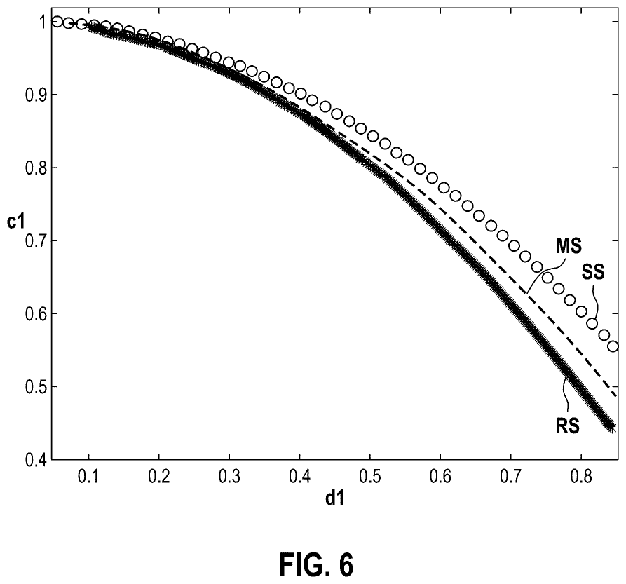

The relationship between equation (1) and equation (3) is shown in FIG. 6 for different signal properties or signal characteristics SC. The signals are normalized to have a variance VAR of one, and c1 and d1 are normalized by the number N.

The first signal shown in FIG. 5 is noise, i.e. a noise signal RS that can be generated with a random number generator. The noise signal RS fulfills the first signal characteristic SC1.

The second signal is a sinusoidal signal SS. The sinusoidal signal SS fulfills the third signal characteristic SC3.

The third signal is a mixed signal MS, which is made up of random noise RS and a sinusoidal signal SS.

In order to generate signals with different correlation values, the randomly generated noise can be low-pass-filtered with different cutoff frequencies. For each cutoff frequency, for example ten signals are generated for which correlation measures c1 and d1 can be calculated. Each marker represents the correlation value for a signal.

As can be seen in FIG. 6, there is an antiproportional relationship between the first correlation measure c1 and the second correlation measure d1. If c1=1, then d1=0. The further curve then depends on the underlying signal, as shown in FIG. 6. The curve of the different correlation values (c1, d1) between consecutive samples differs between a noise signal RS and a sinusoidal signal SS. The curve of the correlation values (c1, d1) for a mixed signal MS, which is mixed from a noise signal RS and a sinusoidal signal SS, lies between the two other curves, i.e. between the curve of the correlation values (c1, d1) for a sinusoidal signal SS and for a noise signal RS.

FIG. 6 shows that the first correlation value c1 calculated according to equation (1) and the second correlation value d1 calculated according to equation (3) are both an indicator of the correlation between consecutive sample values of a signal. However, there is no fixed relationship between the first correlation value c1 calculated according to equation (1) and the second correlation value d1 calculated according to equation (3). The ratio between the first correlation value c1 and the second correlation value d1 depends on the signal characteristic SC of the signal SIG.

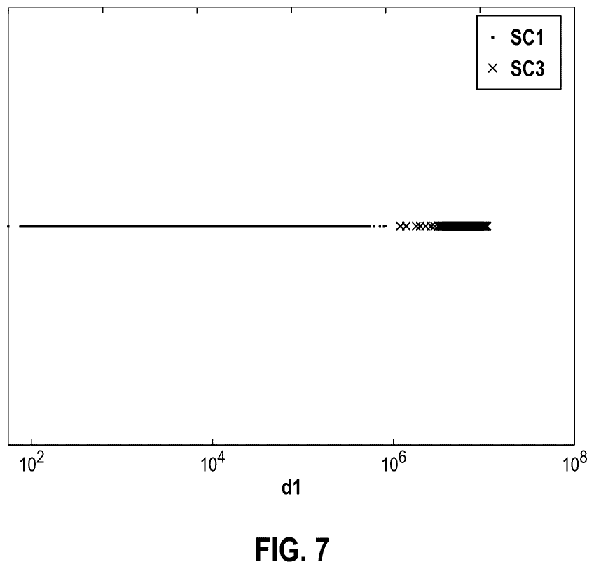

The calculation of the first correlation value c1 according to equation (1) and the calculation of the second correlation value d1 according to equation (3) therefore allows a conclusion to be drawn about the signal characteristic SC. Depending on the ratio v (v=c1/d1) of c1 and d1 the signal is more “noise-like” (SC1) or more “sinusoidal” (SC3). If the second correlation value d1 is entered for the different signals from FIG. 5, the distribution for the different signal properties SC differs from FIG. 5. The distribution of the second correlation value d1 can be seen in FIG. 7. In FIG. 7, the correlation value d1 based on equation (3) is plotted for both the signal characteristic SC1 (noise) and the signal characteristic SC3 (sine). The signal characteristic SC2 (fixed signal) is not shown in FIG. 7, since the correlation value d1 for this signal characteristic SC2 is always zero.

The idea behind the calculation of the correlation value d1 according to equation (3) is that the total change between consecutive samples or sample values is accumulated or summed up.

If the accumulated total change between consecutive sample values is large (d1 large), the consecutive sample values of the signal are only weakly correlated with each other (i.e. noise SC1).

If, on the other hand, the accumulated total change between consecutive sample values is small (d1 small), these consecutive sample values are more strongly correlated with each other (more regular signal SC3).

When the accumulated total change between consecutive sample values is zero (d1=0), the value of the consecutive sample values is equal and the correlation of the consecutive sample values is at its highest (fixed or constant signal SC2).

In the method according to the present invention, the sum of all differences is calculated and compared with a reference value or threshold value SW. This provides greater robustness against outliers.

The detection of noise in general is possible with the method according to the present invention. The difference between consecutive values, calculated periodically between feedback messages, varies. As soon as a counter threshold for the number N of sample values in the sampling sequence is exceeded, the counter Z is reset.

Conventional algorithms also consider duration relative to the total samples, and therefore the differences in duration vary depending on the thresholds mentioned above. However, in the method according to the present invention, the decision-making takes place periodically, i.e. after every fixed number N of samples or sample values. The algorithm according to the present invention is efficient in decision-making and requires relatively little computational effort.

The correlation value d1 calculated according to equation (3) can be used to detect noise in the following way. First, N samples, or sample values, are collected before the correlation value d1 is calculated according to equation (3). If the calculated correlation value d1 exceeds a certain threshold SW (d1>SW) the signal is a noise signal RS (SC1), and if the calculated correlation valued1 is zero (d1=0) the signal is fixed (SC2). In all other cases the signal is assessed as regular (SC3).

Since the collection of N samples requires storage space, it is also possible to calculate the second correlation value d1 iteratively. The iterative calculation of the second correlation value d1 is given in equation (5):

$$\begin{matrix}{d}_{1 , n} = {\sum }_{i = 1}^{n - 1} \vert {x}_{i + 1} \cdot {x}_{i} \vert \\ = \vert {x}_{n} - {x}_{n - 1} \vert + {\underbrace{{\sum }_{i = 1}^{n - 2} \vert {x}_{i + 1} - {x}_{i} \vert}}_{{d}_{1 , n - 1}} , n ∈ [ 2 , 3 , ... , N ]\end{matrix}$$

In the iterative calculation given in equation (5), only the value of the previous length d1,n−1 and the last sample xn−1 have to be saved. With these two values and the current value xn the second correlation value d1 can be calculated.

In one embodiment of the method according to the present invention, the correlation value d1 is calculated according to equation (3), wherein first all samples or sample values are collected and stored in a buffer memory before the calculation of the correlation value d1. However, since this requires storage capacity and takes up a certain amount of memory, in one possible alternative embodiment of the method according to the present invention, the calculation of the correlation value d1 is carried out iteratively according to equation (5).

Although the present invention has been completely described above with reference to preferred exemplary embodiments, it is not limited thereto, but can be modified in many ways.

What is claimed is:

1. A method for detecting a signal characteristic of a sensor signal originating from a sensor, comprising the following steps:
sampling the sensor signal at a sampling rate to generate sample values;
calculating a correlation measure for the sensor signal by summing up absolute differences between two consecutive sample values of a sampling sequence of the sampled sensor signal, wherein the sampling sequence includes a certain number, N, of sample values; and
determining a signal characteristic of the sensor signal based on the calculated correlation measure.

2. The method according to claim 1, wherein the calculated correlation measure is compared with a threshold value.

3. The method according to claim 2, wherein the sensor signal is classified as noise-like when the calculated correlation measure is above the threshold value.

4. The method according to claim 3, wherein the sensor signal is classified as regular when the calculated correlation measure is below the threshold value.

5. The method according to claim 4, wherein the sensor signal is classified as constant when the calculated correlation measure is zero.

6. The method according to claim 1, wherein the sample values of the sampling sequence are temporarily stored and the calculation of the correlation measure is carried out bsed on the temporarily stored sample values of the sampling sequence.

7. The method according to claim 1, wherein the calculation of the correlation measure is carried out iteratively without temporary storage of the sample values of the sampling sequence.

8. The method according to claim 1, wherein a further correlation measure for the sensor signal is calculated by summing up products of two consecutive sample values of a sampling sequence of the sampled sensor signal, wherein the sampling sequence includes the certain number, N, of sample values.

9. The method according to claim 8, wherein the correlation measure and the further correlation measure calculated for the sensor signal are stored in pairs.

10. The method according to claim 9, wherein a ratio between the correlation measure and the further correlation measure is calculated.

11. The method according to claim 10, wherein the signal characteristic of the sensor signal is further specified depending on the calculated ratio of the correlation measure and the further correlation measure to one another for a specific value of one of the correlation measure and the further correlation measure.

12. The method according to claim 1, wherein the determined signal characteristic of the sensor signal is used to assess whether the sensor is operating correctly or has a malfunction.

13. The method according to claim 12, wherein after a malfunction in the sensor has been detected, an operating mode for handling the detected malfunction is automatically activated.

14. The method according to claim 1, wherein the sensor signal is output by a MEMS sensor of a gyroscope.

15. A device for detecting a signal characteristic of a sensor signal originating from a sensor, the device comprising:
a sampling unit configured to sample the sensor signal at a sampling rate to generate sample values;
a calculation unit configured to calculate a correlation measure for the sensor signal by summing up the absolute differences between two consecutive sample values of a sampling sequence of the sampled sensor signal, wherein the sampling sequence includes a certain number, N, of sample values; and
a determination unit configured to determine a signal characteristic of the sensor signal based on the calculated correlation measure.

16. The device according to claim 15, wherein the determination unit includes a comparator which compares the correlation measure calculated by the calculation unit with a threshold value, wherein the sensor signal is classified by the determination unit as noise-like if the calculated correlation measure is above the threshold value, wherein the sensor signal is classified by the determination unit as regular if the calculated correlation measure is below the threshold value, and wherein the sensor signal is classified by the determination unit as constant if the calculated correlation measure is zero.

17. The device according to claim 15, wherein the device has a buffer memory for temporarily storing the sample values of the sampling sequence generated by the sampling unit.

18. The device according to claim 15, wherein the calculation unit of the device is configured to calculate a further correlation measure for the sensor signal by summing up products of two consecutive sample values of a sampling sequence of the sampled sensor signal, wherein the sampling sequence includes the certain number, N, of sample values.

19. The device according to claim 18, wherein the correlation measure and the further correlation measure calculated by the calculation unit for the sensor signal are stored in pairs in a data memory of the device.

20. The device according to claim 18, wherein the calculation unit of the device calculates a ratio between the correlation measure and the further correlation measure.

21. The device according to claim 19, wherein the determination unit of the device further specifies the signal characteristic of the sensor signal based on the ratio, calculated by the calculation unit, of the correlation measure and the further correlation measure to one another for a specific value of one of the the correlation measure and the further correlation measure.

22. The device according to claim 15, wherein an assessment unit of the device assesses, based on the determined signal characteristic of the sensor signal, whether the sensor is functioning correctly or has a malfunction.

23. The device according to claim 22, wherein the assessment unit outputs an activation signal for activating an operating mode for handling a malfunction of the sensor if a malfunction of the sensor is detected based on the determined signal characteristic.

24. A system, comprising:
at least one sensor; and
a device for detecting a signal characteristic of a sensor signal originating from the sensor, the device including:
a sampling unit configured to sample the sensor signal at a sampling rate to generate sample values,
a calculation unit configured to calculate a correlation measure for the sensor signal by summing up the absolute differences between two consecutive sample values of a sampling sequence of the sampled sensor signal, wherein the sampling sequence includes a certain number, N, of sample values, and
a determination unit configured to determine a signal characteristic of the sensor signal based on the calculated correlation measure.

25. The system according to claim 24, wherein the sensor is a MEMS sensor.
